(19) United States
(12) Patent Application Publication
(10) Pub. No.: US 2025/0004155 A1
(43) Pub. Date: Jan. 2, 2025

(54) REVERSE TIME MIGRATION NOISE REMOVAL USING A DEPTH-DEPENDENT WAVENUMBER FILTER

(71) Applicant: ARAMCO SERVICES COMPANY, Houston, TX (US)

(72) Inventors: Hong Liang, Katy, TX (US); Houzhu Zhang, Houston, TX (US)

(73) Assignee: ARAMCO SERVICES COMPANY, Houston, TX (US)

(21) Appl. No.: 18/343,180

(22) Filed: Jun. 28, 2023

(51) Int. Cl. G01V 1/32; E21B 44/00; E21B 49/00; G01V 1/30; G01V 1/36

(52) U.S. Cl. CPC G01V 1/325; E21B 44/00; E21B 49/00; G01V 1/303; G01V 1/368; E21B 2200/20

(57) ABSTRACT

Examples of methods and systems are disclosed. The methods may include obtaining a seismic data regarding a subsurface region of interest, wherein the seismic data comprises a plurality of time-space waveforms. The methods may also include obtaining a seismic velocity model. The methods may further include determining a migrated seismic image based on the plurality of time-space waveforms and the seismic velocity model. The method may still further include generating a filtered seismic image by applying a depth-dependent attenuation operator to the migrated seismic image and determining a drilling target in the subsurface region based on the filtered seismic image.

### BACKGROUND

In the oil and gas industry, seismic surveys are conducted over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and may store a time-series of samples of earth motion caused by the seismic waves. The collection of time-series of samples recorded at many receiver locations generated by a seismic source at many source locations constitutes a seismic data set.

To determine the earth structure, including the presence of hydrocarbons, the seismic data set may be processed. Processing a seismic data set includes a sequence of steps designed to correct for a number of issues, such as near-surface effects, noise, irregularities in the seismic survey geometry, etc. A properly processed seismic data set may aid in decisions as to if and where to drill for hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method. The method includes obtaining a seismic data regarding a subsurface region of interest, where the seismic data comprises a plurality of time-space waveforms, and obtaining a seismic velocity model. The method further includes determining a migrated seismic image based on the plurality of time-space waveforms and the seismic velocity model. The method still further includes generating a filtered seismic image by applying a depth-dependent attenuation operator to the migrated seismic image and determining a drilling target in the subsurface region based on the filtered seismic image.

In general, in one aspect, embodiments disclosed herein relate to a system. The system includes a seismic acquisition system configured to record seismic data regarding a subsurface region of interest, wherein the seismic data comprises a plurality of time-space waveforms. The system also includes a seismic processor configured to receive the seismic data and to obtain a seismic velocity model. The seismic processor is also configured to determine a migrated seismic image based on the plurality of time-space waveforms and the seismic velocity model. The seismic processor is further configured to generate a filtered seismic image by applying a depth-dependent attenuation operator to the migrated seismic image and to determine a drilling target in the subsurface region based on the filtered seismic image.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a seismic acquisition system of a subsurface region of interest, according to one or more embodiments of the present disclosure.

FIG. 2 shows examples of seismic data produced by a seismic acquisition system in accordance with one or more embodiments.

FIG. 3 illustrates a velocity model for subsurface structure according to one or more embodiments.

FIG. 4 shows examples of migrated seismic images, according to one or more embodiments.

FIG. 5 shows a drilling system in accordance with one or more embodiments.

FIG. 6 shows a flowchart in accordance with one or more embodiments.

FIG. 7 shows examples of filtered seismic images, according to one or more embodiments.

FIG. 8 shows examples of filtered seismic images in the wavenumber domain, according to one or more embodiments.

FIG. 9 depicts a schematic diagram of a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

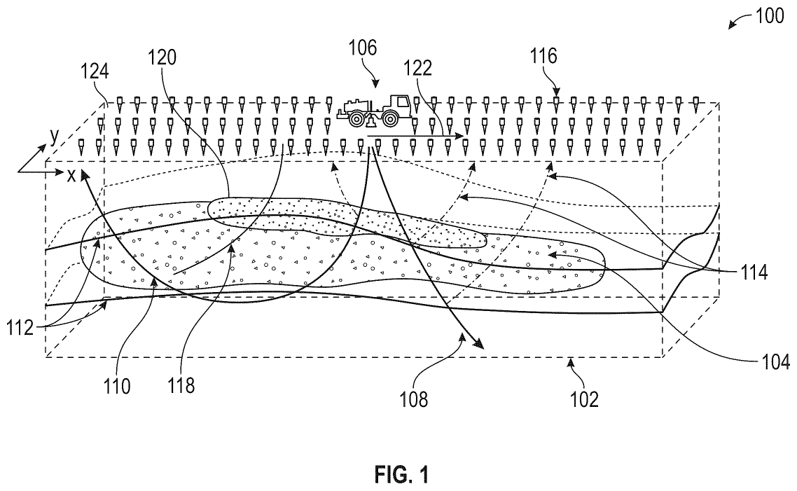

In the following description of FIGS. 1-9, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic signal” includes reference to one or more of such seismic signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

In general, disclosed embodiments include systems and methods to filter low-wavenumber noise in migrated seismic images. In particular, some embodiments acquire seismic signals during geophysical explorations to map the structure of a subsurface region. The seismic signals may be composed of diffracted and/or reflected seismic energy, due to the presence of subsurface interfaces and/or diffractors. Reverse time migration (RTM) is a high-resolution seismic imaging technology aimed to recover the subsurface structure from recorded seismic data. The RTM technique is based on the simulation of wavefields propagating in all directions, and thus it can image complex geological structures without dip limitation. Seismic images generated with RTM are known as “migrated seismic images”.

However, low-wavenumber noise may be present in migrated seismic images due to backscattering energy generated by models with high-contrast boundaries that are used by the RTM algorithm. Other sources of low-wavenumber noise include cross-correlation of head waves and diving waves. In some embodiments, a Laplacian operator is applied to reduce the high amplitude low-wavenumber artifacts generated by RTM algorithms. However, although the Laplacian operator may diminish the low-wavenumber noise, it may as well increase the high-wavenumber noise in the seismic image. Methods and processing techniques to reduce the low-wavenumber noise without amplifying the high-wavenumber noise may assist in improving the quality of the generated seismic images.

The resulting seismic image may then be used for further seismic data interpretation, such as defining the spatial location and extent of a hydrocarbon reservoir. Thus, the disclosed methods are integrated into the established practical applications for improving seismic images and searching for an extraction of hydrocarbons from subsurface hydrocarbon reservoirs. The disclosed methods represent an improvement over existing methods for at least the reasons of lower cost and increased efficacy.

FIG. 1 shows a seismic acquisition system (100) of a subsurface region of interest (102), according to one or more embodiments. In some cases, the subsurface region of interest (102) may lie beneath a lake, sea, or ocean. In other cases, the subsurface region of interest (102) may lie beneath an area of dry land. The subsurface region of interest (102) may contain a hydrocarbon deposit (120) that may form part of a hydrocarbon reservoir (104). The seismic acquisition system (100) may utilize a seismic source (106) that generates radiated seismic waves (108). The type of seismic source (106) may depend on the environment in which it is used. For example, on land the seismic source (106) may be a vibroseis truck or an explosive charge, but in water the seismic source (106) may be an airgun. The radiated seismic waves (108) may return to the surface as refracted seismic waves (110) or reflected seismic waves (114).

Refracted seismic waves (110) and reflected seismic waves (114) may occur, for example, due to geological discontinuities (112) that may be also known as “seismic reflectors”. The geological discontinuities (112) may be, for example, planes or surfaces that mark changes in physical or chemical characteristics in a geological structure. The geological discontinuities (112) may also be boundaries between faults, fractures, or groups of fractures within a rock. The geological discontinuities (112) may delineate a hydrocarbon reservoir (104).

At the surface, refracted seismic waves (110) and reflected seismic waves (114) may be detected by seismic receivers (116). Radiated seismic waves (108) that propagate from the seismic source (106) directly to the seismic receivers (116), known as direct seismic waves (122), are also detected by the seismic receivers (116).

In some embodiments, a seismic source (106) may be positioned at a location denoted (xₛ, yₛ), where x and y represent orthogonal axes on the earth's surface above the subsurface region of interest (102). The seismic receivers (116) may be positioned at a plurality of seismic receiver locations denoted (xᵣ, yᵣ), with the distance between each receiver and the source being termed “the source-receiver offset”, or simply “the offset”. Thus, the direct seismic waves (122), refracted seismic waves (110), and reflected seismic waves (114) generated by a single activation of the seismic source (106) may be represented in the axes (xₛ, yₛ, xᵣ, yᵣ, t). The t-axis indicates the recording time between the activation of the seismic acquisition system (100) and the sample time at which the seismic wave is detected by the seismic receivers (116).

Seismic processing may reduce five-dimensional seismic data produced by a seismic acquisition system (100) to three-dimensional (x,y,t) seismic data by, for example, correcting the recorded time for the time of travel from the seismic source (106) to the seismic receiver (116) and summing (“stacking”) samples over two horizontal space dimensions. Stacking of samples over a predetermined time interval may be performed as desired, for example, to reduce noise and improve the quality of the signals.

Seismic data may also refer to data acquired at different time intervals, such as, for example, in cases where seismic surveys are repeated after a period of weeks, months, or years, to obtain time-lapse data. Seismic data may also be pre-processed or partially-processed data, e.g., arranged as “common shot gathers” (CSG), i.e., sorting waveforms as acquired by different receivers and having a single source location. The type of seismic data is not intended as limiting, and any other suitable seismic data is intended to fall within the scope of the present disclosure.

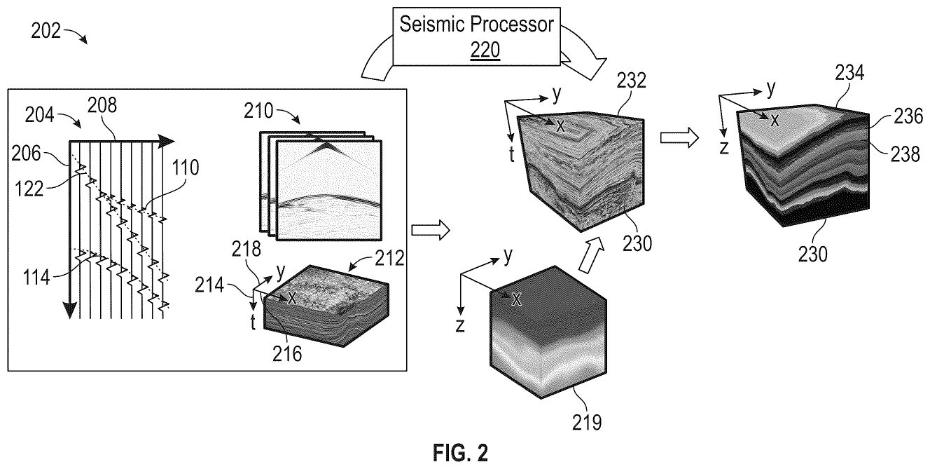

FIG. 2 shows examples of seismic data (202) produced by a seismic acquisition system (100) in accordance with one or more embodiments. An example of a CSG (204) illustrates direct seismic waves (122), refracted seismic waves (110), and reflected seismic waves (114) generated by a single activation of the seismic source (106) and recorded by a several seismic receivers (116) arranged in a line on the surface of the earth. Each seismic receiver (116) may record a time-series representing the amplitude of ground-motion at a sequence of discrete times. This time-series may be denoted or otherwise referred to as a “waveform”.

In the CSG (204) shown in FIG. 2 the vertical axis represents the time scale (206) and the horizontal axis represents the offset (208). In some embodiments, direct seismic waves (122), refracted seismic waves (110), and reflected seismic waves (114) may be identified in the CSG (204) by their arrival times, i.e., the times at which they are first detected by the seismic receivers (116). The location of a particular type of wave in seismic data (202) acquired in time and space, such as in CSG (204), may be termed as an “arrival” or as an “event”.

The CSG (204) illustrates how the arrivals are detected at later times by the seismic receivers (116) that are farther from the seismic source (106). In some embodiments, arrivals of direct seismic waves (122) in the CSG (204) may be characterized by a straight line, while arrivals of reflected seismic waves (114) may present a hyperbolic shape, as seen in FIG. 2. Refracted seismic waves (110) may be characterized by arrivals in the form of almost a straight line.

In one or more embodiments, seismic data (202) acquired by a seismic acquisition system (100) may be arranged in a plurality of CSGs (210) to create a 3D seismic dataset. Alternatively, the seismic data may be represented as a “seismic volume” (212) consisting of a plurality of time-space waveforms with a time axis (214), a first spatial dimension (216), and a second spatial dimension (218), where the first spatial dimension (216) and second spatial dimension (218) are orthogonal and span the Earth's surface above the subsurface region of interest (102).

Seismic data (202) may be processed by a seismic processor (220) to generate a seismic velocity model (219) of the subterranean region of interest (102). A seismic velocity model (219) is a representation of seismic velocity at a plurality of locations within a subterranean region of interest (102). Seismic velocity is the speed at which a seismic wave, that may be a pressure-wave or a shear-wave, travel through a medium. Pressures waves are often referred to as “primary-waves” or “P-waves”. Shear waves are often referred to a “secondary waves” or “S-waves”. Seismic velocities in a seismic velocity model (219) may vary in vertical depth, in one or more horizontal directions, or both. Layers of rock are created from different materials or created under varying conditions. Each layer of rock may have different physical properties from neighboring layers and these different physical properties may include seismic velocity.

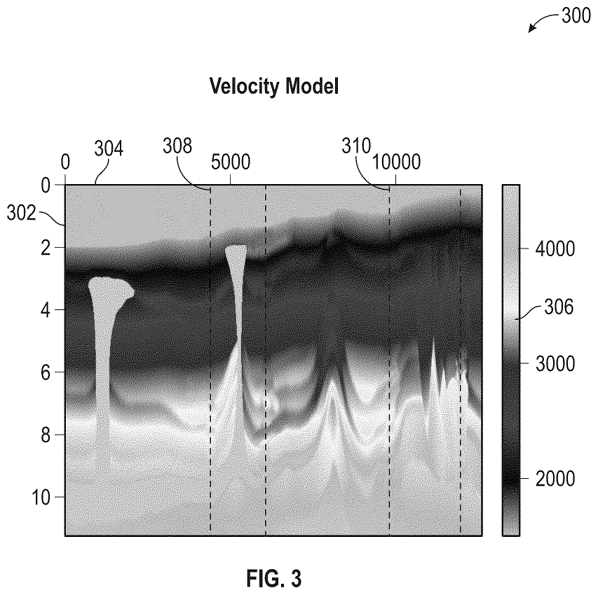

An example of a two-dimensional section through a seismic velocity model is shown in FIG. 3. The seismic velocity model (300) describes a high-contrast P-wave velocity extending to a depth of 36,080 ft (11 km), indicated on the vertical axis (302) and a horizontal distance of over 328,000 ft (100 km), indicated on the horizontal axis (304). The grayscale (306) indicates the amplitude in m/s of the P-wave velocity. The model, part of industry benchmark model known as the BP 2007 TTI model, is an anisotropic velocity model used to test seismic imaging and inversion techniques.

Returning to FIG. 2. FIG. 2 schematically illustrates that in some embodiments seismic data (202) may be processed by a seismic processor (220) to generate a seismic image (230) of the subterranean region of interest (102). For example, a time-domain seismic image (232) may be generated using a process called seismic migration (also referred to as “migration” herein) using a seismic velocity model (219). In seismic migration, seismic events (e.g., reflections, refractions) recorded at the surface are relocated in either time or space to the location the event occurred in the subsurface. In some embodiments, migration may transform pre-processed shot gathers from a time-domain to a depth-domain seismic image (234). In a depth-domain seismic image (234), seismic events in a migrated shot gather may represent geological boundaries (236, 238) in the subsurface. Various types of migration algorithms may be used in seismic imaging. For example, one type of migration algorithm corresponds to reverse time migration.

A seismic image (230) of high resolution may be obtained if densely-recorded data is acquired by using closely-spaced shots and seismic receivers. For example, seismic waves with a bandwidth extending up to 100 Hz or more may resolve thin features. However, strong low-wavenumber noise may be found in seismic images (230) generated with reverse time migration. Artifacts may be generated along the wave paths by a migration algorithm due to cross-correlation of head waves, diving waves, and backscattered waves. Head waves are seismic waves that propagate along an interface or geological discontinuity (112) before arriving to the surface. Diving waves may appear when the seismic velocity increases continuously with depth causing the radiated seismic waves (108) to be gradually refracted and return to the surface. Backscattered waves may be generated when radiated seismic waves (108) encounter an obstacle creating a strong velocity contrast and then interfering scattered waves spread away from the obstacle and in a backward direction relative to the radiated seismic waves (108).

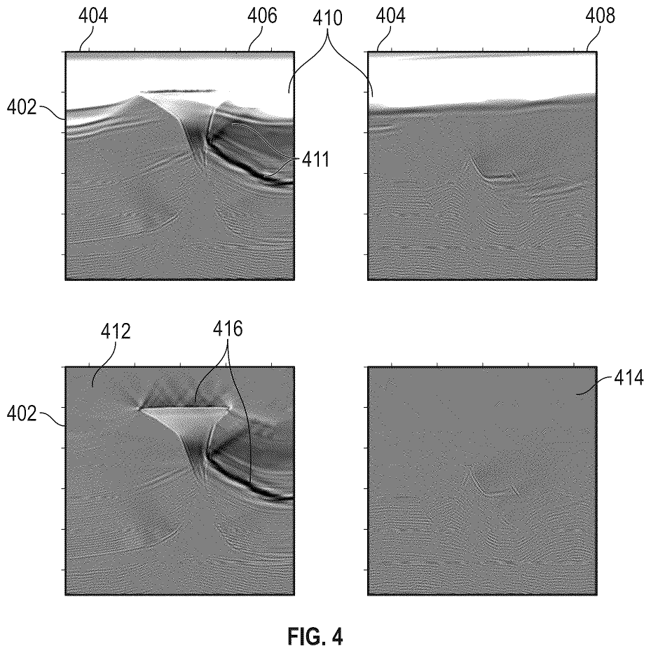

FIG. 4 shows examples of migrated seismic images contaminated with low-wavenumber noise, according to one or more embodiments. The vertical axis indicates the depth (402), and the horizontal axis indicates the horizontal distance (404). Migrated seismic images (406) and (408) are obtained using simulated wavefields and the velocity model of FIG. 3. Specifically, the analysis focuses on the salt area (308) and the fault area (310) of the seismic velocity model (300). Migrated seismic images (406) and (408) correspond to the salt area (308) and the fault area (310), respectively. Strong low-wavenumber noise (410) can be observed on the shallowest portion of both migrated seismic images (406, 408). The strong noise (410) may be result of cross-correlations of head-waves, diving waves and backscattered waves. Furthermore, in migrated seismic image (406) black artifacts (411) are clearly noticeable, corresponding to noise related to waves backscattered by the salt body (308), which has a velocity much higher than the surrounding medium.

In some embodiments, noise due to diving waves may be reduced by filtering late arrivals, in the plurality of time-domain waveforms. An arrival muting filter may be applied to reduce undesired low-wavenumber artifacts. FIG. 4 includes examples of migrated seismic images generated with wavefields that have been filtered with arrival muting filters. Specifically, FIGS. (412) and (414) illustrate the result of applying the arrival muting filter to the simulated wavefields used to generate migrated seismic images (406) and (408) respectively, by using an offset equal to the product of 1200 m/s and the travel time. As seen, the strong noise (410) is not visible in the migrated seismic image (414) corresponding to the fault area (310) and it appears to have been reduced to a desirable level. However, in the migrated seismic image (412), corresponding to the salt area (308), a significant level of high-wavenumber noise (416) remains visible. Processing techniques to remove the low- and high-wavenumber noise from seismic images (230) may improve the quality of the generated migrated seismic images (412, 414).

As illustrated in FIG. 2, processing of seismic data (202) may generate a seismic image (230). The seismic image (230) may be interpreted by a seismic interpreter using a seismic interpretation workstation as containing structures, including geological boundaries (236, 238) delineating the three-dimensional geometry of a subsurface region of interest (102). The geological boundaries (236, 238) may delineate a hydrocarbon reservoir (104). If a seismic image (230) indicates the presence of hydrocarbons in the subsurface region of interest (102), a drilling system may drill a wellbore (118) to access those hydrocarbons.

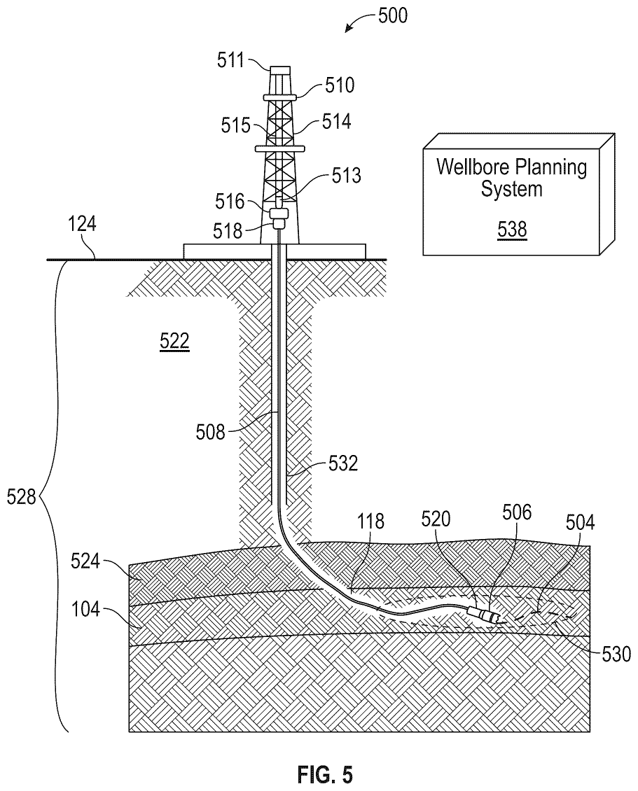

FIG. 5 shows a drilling system (500) in accordance with one or more embodiments. As shown in FIG. 5, a wellbore (118) following a wellbore trajectory (504) may be drilled by a drill bit (506) attached by a drillstring (508) to a drilling rig (510) located on the surface (124) of the earth. The drilling rig (510) may include framework, such as a derrick (514) to hold drilling machinery. A crown block (511) may be mounted at the top of the derrick (514), and a traveling block (513) may hang down from the crown block (511) by means of a cable (515) or drilling line. One end of the cable (515) may be connected to a drawworks (not shown), which is a reeling device that may be used to adjust the length of the cable (515) so that the traveling block (513) may move up or down the derrick (514).

A top drive (516) provides clockwise torque via the drive shaft (518) to the drillstring (508) in order to drill the wellbore (118). The drillstring (508) may comprise a plurality of sections of drillpipe attached at the uphole end to the drive shaft (518) and downhole to a bottomhole assembly (“BHA”) (520). The BHA (520) may be composed of a plurality of sections of heavier drillpipe and one or more measurement-while-drilling (“MWD”) tools configured to measure drilling parameters, such as torque, weight-on-bit, drilling direction, temperature, etc., and one or more logging-while-drilling (“LWD”) tools configured to measure parameters of the rock surrounding the wellbore (118), such as electrical resistivity, density, sonic propagation velocities, gamma-ray emission, etc. MWD and logging tools may include sensors and hardware to measure downhole drilling parameters, and these measurements may be transmitted to the surface (124) using any suitable telemetry system known in the art. The BHA (520) and the drillstring (508) may include other drilling tools known in the art but not specifically listed.

The wellbore (118) may traverse a plurality of overburden (522) layers and one or more seals or cap-rock formations (524) to a hydrocarbon reservoir (104) within the subterranean region (528), and specifically to a drilling target (530) within the hydrocarbon reservoir (104). The wellbore trajectory (504) may be a curved or a straight. All or part of the wellbore trajectory (504) may be vertical, and some portions of the wellbore trajectory (504) may be deviated from the vertical or horizontal. One or more portions of the wellbore (118) may be cased with casing (532) in accordance with a wellbore plan.

To start drilling, or “spudding in” the well, the hoisting system lowers the drillstring (508) suspended from the derrick (514) towards the planned surface location of the wellbore (118). An engine, such as an electric motor, may be used to supply power to the top drive (516) to rotate the drillstring (508) through the drive shaft (518). The weight of the drillstring (508) combined with the rotational motion enables the drill bit (506) to bore the wellbore (118).

The drilling system (500) may be disposed at and communicate with other systems in the well environment, such as a seismic processor (220) and a wellbore planning system (538). The drilling system (500) may control at least a portion of a drilling operation by providing controls to various components of the drilling operation. In one or more embodiments, the drilling system (500) may receive well-measured data from one or more sensors and/or logging tools arranged to measure controllable parameters of the drilling operation. During operation of the drilling system (500), the well-measured data may include mud properties, flow rates, drill volume and penetration rates, rock physical properties, etc.

In some embodiments, the rock physical properties may be used by a seismic processor (220) to determine a location of a hydrocarbon reservoir (104) (or other subterranean features). Knowledge of the existence and location of the hydrocarbon reservoir (104) and other subterranean features may be transferred from the seismic processor (220) to a wellbore planning system (538). The wellbore planning system (538) may use information regarding the hydrocarbon reservoir (104) location to plan a well, including a wellbore trajectory (504) from the surface (124) of the earth to penetrate the hydrocarbon reservoir (104). In addition, to the depth and geographic location of the hydrocarbon reservoir (104), the planned wellbore trajectory (504) may be constrained by surface limitations, such as suitable locations for the surface position of the wellhead, i.e., the location of potential or preexisting drilling rigs, drilling ships or from a natural or man-made island.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. Information regarding the planned wellbore trajectory (504) may be transferred to the drilling system (500) described in FIG. 5. The drilling system (500) may drill the wellbore (118) along the planned wellbore trajectory (504) to access the drilling target (530) in the hydrocarbon reservoir (104).

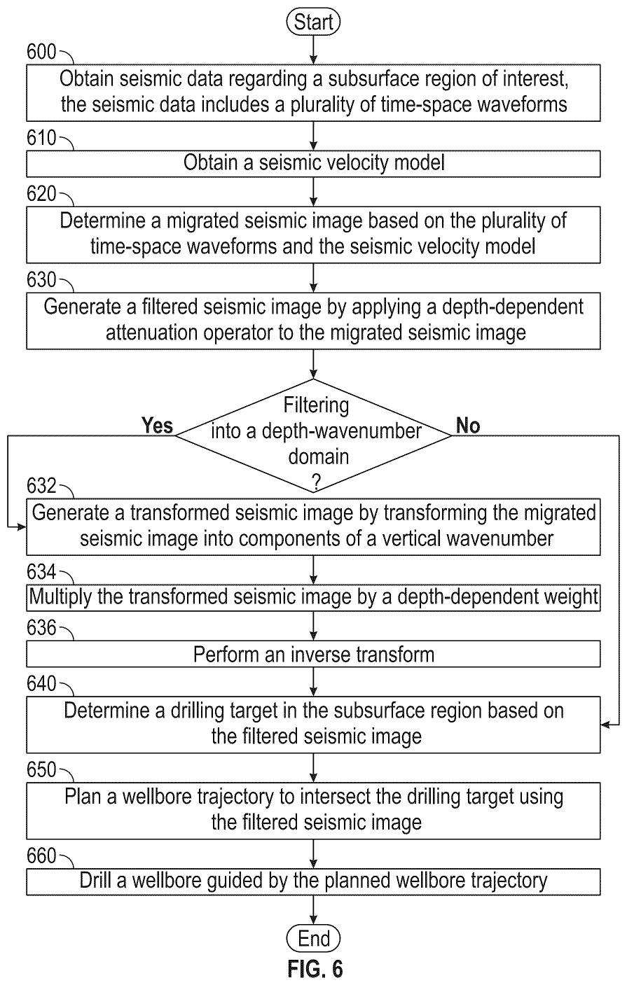

Turning to FIG. 6, FIG. 6 shows a flowchart in accordance with one or more embodiments. Specifically, FIG. 6 describes a general method to filter a seismic image using a depth-dependent operator. While the various blocks in FIG. 6 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 600, seismic data (202) associated with a subsurface region of interest is obtained, in accordance with one or more embodiments. The seismic data (202) may be acquired using a seismic acquisition system (100) above a subsurface region of interest (102). The seismic data (202) may be processed to attenuate noise and may be organized in one or more spatial dimensions (216, 218) and a time axis (214) to form a plurality of time-space waveforms. In some embodiments, one or more CSGs (210) may be generated with the source position corresponding to the middle of the offset, as illustrated in FIG. 2.

In Block 610, a seismic velocity model regarding the subsurface region of interest is obtained, in accordance with one or more embodiments. The seismic velocity model (219) provides an estimate of at least one seismic wave propagation velocity at each location in the depth domain within the subterranean region of interest (102). Typically, a seismic velocity model (219) is specified by at least one seismic velocity for a particular wave type at a plurality of discrete grid points spanning the subsurface region of interest, but other specifications are possible. For example, the seismic velocity model (219) may be defined by a plurality of continuously varying mathematical functions.

An accurate velocity model may be useful for accurate simulations of seismic wave propagation in the subsurface. A velocity model may be constructed by processing recorded seismic data (202) obtained using a seismic acquisition system (100). Processing seismic data (202) to obtain a velocity model may be considered an inverse problem, where the applied process must determine the subsurface velocity model that resulted in the recorded seismic data (202). The various processes and techniques used to process seismic data (202) to form a velocity model may generally be categorized as either a “data-domain approach”, such as full-waveform inversion (FWI), or an “image-domain approach”, such as migration velocity analysis. Machine learning models and deep learning frameworks may be also implemented to determine a velocity model from given seismic data (202).

Returning to FIG. 6, in Block 620, a migrated seismic image is determined based on the plurality of time-space waveforms and the seismic velocity model, in accordance with one or more embodiments. Various types of algorithms may be used in the generation of the migrated seismic image (230). For example, the plurality of time-space waveforms may include a source wavefield and a receiver wavefield. The source wavefield may include one or more source functions at one or more source locations (xₛ, yₛ) used during activation of the seismic source (106). The receiver wavefield may include the plurality of waveforms acquired at the seismic receivers (116).

In some embodiments, the migrated seismic image may be generated with reverse time migration (RTM) using the two-way wave equation. In RTM, the source wavefield may be obtained by forward modelling the propagation of a synthetic source function using the seismic velocity model (219). A receiver wavefield may be generated using the same seismic velocity model (219) by backward propagating in time the receiver wavefield. In other words, the receiver wavefield may be first reversed in time and the used as a source function applied at the corresponding seismic receivers (116) to simulate a radiated wavefield.

The migrated seismic image may then be formed by applying an imaging condition to the receiver wavefield and the source wavefield. In some embodiments, the first imaging condition may be represented by a cross-correlation between the source wavefield with the receiver wavefield under the basic assumption that the source wavefield represents the down-going wave-field and the receiver wave-field the up-going wave-field.

In some embodiments the migrated seismic image (230) may be obtained by merging, or stacking, different partial migrated seismic images. Each partial migrated seismic image may be generated from seismic data (202) acquired upon activation of one or more seismic sources (106).

Returning to FIG. 6, in Block 630, a filtered seismic image is generated by applying a depth-dependent attenuation operator to the migrated seismic image, in accordance with one or more embodiments. Application of a post-image filtering technique may provide an effective and computational efficient method to improve the quality of the migrated seismic image. For example, a non-limiting embodiment may apply a post-imaging Laplacian-like operator to the whole migrated seismic image. Application of a conventional Laplacian operator to a migrated seismic image I(x, y, z) may be expressed as:

$${I}_{f} ( x , y , z ) = {V}^{2} ( x , y , z ) ( \frac{{\partial }^{2}}{\partial {x}^{2}} + \frac{{\partial }^{2}}{\partial {y}^{2}} + \frac{{\partial }^{2}}{\partial {z}^{2}} ) I ( x , y , z ) \qquad ( 1 )$$

where (x, y, z) are the spatial coordinates, I_{f}(x, y, z) is the filtered seismic image, V(x, y, z) is the seismic velocity model (219), and ∂²/∂( )² denotes the second partial derivative of its argument. In other embodiment, the effect of the velocity model is not considered, and the application of a Laplacian operator may simplify to:

$${I}_{f} ( x , y , z ) = ( \frac{{\partial }^{2}}{\partial {x}^{2}} + \frac{{\partial }^{2}}{\partial {y}^{2}} + \frac{{\partial }^{2}}{\partial {z}^{2}} ) I ( x , y , z ) \qquad ( 2 )$$

Furthermore, Equation (2) may be transformed into the wavenumber domain:

$${\tilde{I}}_{f} ( {k}_{x} , {k}_{y} , {k}_{z} ) = - ( {k}_{x}^{2} + {k}_{y}^{2} + {k}_{z}^{2} ) \tilde{I} ( {k}_{x} , {k}_{y} , {k}_{z} ) \qquad ( 3 )$$

where kₓ, k_{y}, and k_{z} are the wavenumbers in the x-, y-, and z-dimensions, respectively. A transformed seismic image Ĩₓ(kₓ, y, z) may be generated, for example, by decomposing a migrated seismic image I(x, y, z) into components of a spatial frequency in the x-dimension, also known as wavenumber kₓ. Further decompositions in wavenumbers of the other y- and z-dimensions may be performed to generate the transformed seismic image Ĩ(kₓ, k_{y}, k_{z}). In some embodiments, the transformation of the seismic image in wavenumber components may be performed with Fourier Transforms.

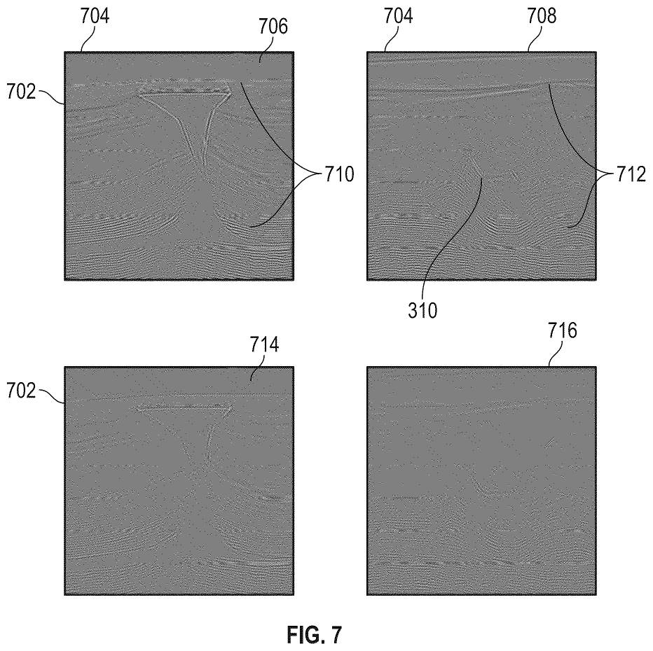

Turning to FIG. 7, FIG. 7 shows examples of filtered seismic images, according to one or more embodiments. In all images of FIG. 7 the vertical axis indicates the depth (702), and the horizontal axis indicates the horizontal distance (704). Filtered seismic images (706) and (708) correspond to the results of filtering migrated seismic images (406) and (408) respectively, with the Laplacian operator as expressed in Equation (2). It should be noted that migrated seismic images (406) and (408) are not processed with the arrival muting filter. It can be observed in filtered seismic image (706) that the filtering method of Equation (2) effectively attenuates the low-wavenumber noise (410, 411). However, the filtering method of Equation (2) also amplifies a high-wavenumber noise (710) that is not visible in the migrated seismic image (412) processed with the arrival muting filter. A similar effect can be seen in filtered seismic image (708), corresponding to the fault area (310), where a high-wavenumber noise (712) appears after applying the Laplacian operator according to Equation (2).

Returning to FIG. 4, by inspection of the migrated seismic images shown in FIG. 4 it may be noted that the strong noise (410) is distributed in the shallowest regions of the migrated seismic images (406) and (408) and that noise decreases with depth. It may thus be desirable to apply a Laplacian operator that provides less attenuation at larger depths, and that may avoid the amplification of high-wavenumber noise illustrated in seismic images (706) and (708). In some embodiments, a depth-dependent attenuation operator may be applied to the migrated seismic image in which the attenuation decreases with depth.

According to one or more embodiments, a depth-dependent attenuation filtering may be applied in a wavenumber domain. The migrated seismic image I(x, y, z) may be transformed into a transformed seismic image Ĩ_{z}(x, y, z, k_{z}) that is also a function of the vertical wavenumber k_{z}, as shown in Block 632 of FIG. 6. Transformation of the migrated seismic image I(x, y, z) into the transformed seismic image Ĩ_{z}(x, y, z, k_{z}) may be obtained by spectral decomposition. After spectral decomposition, at each (x, y) point there is a plurality of depth-varying k_{z}-components, and thus the resulting transformed seismic image may be expressed as Ĩ_{z}(x, y, z, k_{z}). According to some embodiments, spectral decomposition may be performed using short-window Fourier transforms, Gabor transforms or S-transforms, continuous wavelet transforms, or Wigner distributions. Other methods of spectrally decomposing a seismic image (230) known to one skilled in the art may be used without departing from the scope of the invention.

Combined with the transformed seismic image Ĩ_{z}(x, y, z, k_{z}), the filtering operation with a Laplacian operator may be expressed as:

$${\tilde{I}}_{fz} ( x , y , z , {k}_{z} ) = ( \frac{{\partial }^{2}}{\partial {x}^{2}} + \frac{{\partial }^{2}}{\partial {y}^{2}} - {k}_{z}^{2} ) {\tilde{I}}_{z} ( x , y , z , {k}_{z} ) \qquad ( 4 )$$

In some embodiments, the transformed seismic image Ĩ_{z}(x, y, z, k_{z}) may be multiplied by a depth-dependent weight, as shown in Block 634. Furthermore, the depth-dependent weight may be a Laplacian-like operator. A depth-dependent attenuation operator may then be obtained by replacing the exponent of the term related to the wavenumber k_{z} in Equation (4) by a function of depth α(z), as follows:

$${\tilde{I}}_{fz} ( x , y , z , {k}_{z} ) = ( \frac{{\partial }^{2}}{\partial {x}^{2}} + \frac{{\partial }^{2}}{\partial {y}^{2}} - {k}_{z}^{α ( z )} ) {\tilde{I}}_{z} ( x , y , z , {k}_{z} ) \qquad ( 5 )$$

According to some embodiments the function α(z) is defined to make the exponent of k_{z} less than 2, in order to reduce the attenuation effect of the filter. A non-limiting example of a function that reduces the exponent of the wavenumber k_{z} with depth may be given by the expression:

$$α ( z ) = 2 - 0.5 * \frac{z - {z}_{min}}{{z}_{max} - {z}_{min}} \qquad ( 6 )$$

where the parameters zₘᵢₙ and zₘₐₓ are the minimum depth and the maximum depth of the migrated seismic image (230), respectively. With the exponent of the power function k_{z}^{α(z)} going from 2 to 1.5, the effect of the attenuation operator in Equation (5) diminishes with depth. The final filtered seismic image I_{f}(x, y, z) may then be obtained by performing inverse transformation of the filtered transformed seismic image Ĩ_{fz}(x, y, z, k_{z}), as shown in Block 636.

Examples that demonstrate the capabilities of the proposed method are shown in FIG. 7. Filtered seismic images (714) and (716) correspond to the results of filtering migrated seismic images (406) and (408) respectively, with the depth-dependent attenuation filtering as expressed in Equations (5) and (6). Filtered seismic images (714, 716) show that the low-wavenumber noise is effectively removed with the depth-dependent attenuation filtering method, without amplifying high-wavenumber artifacts. When compared with filtered seismic images (706, 708) the overall quality of seismic images (714,716) appears to be superior.

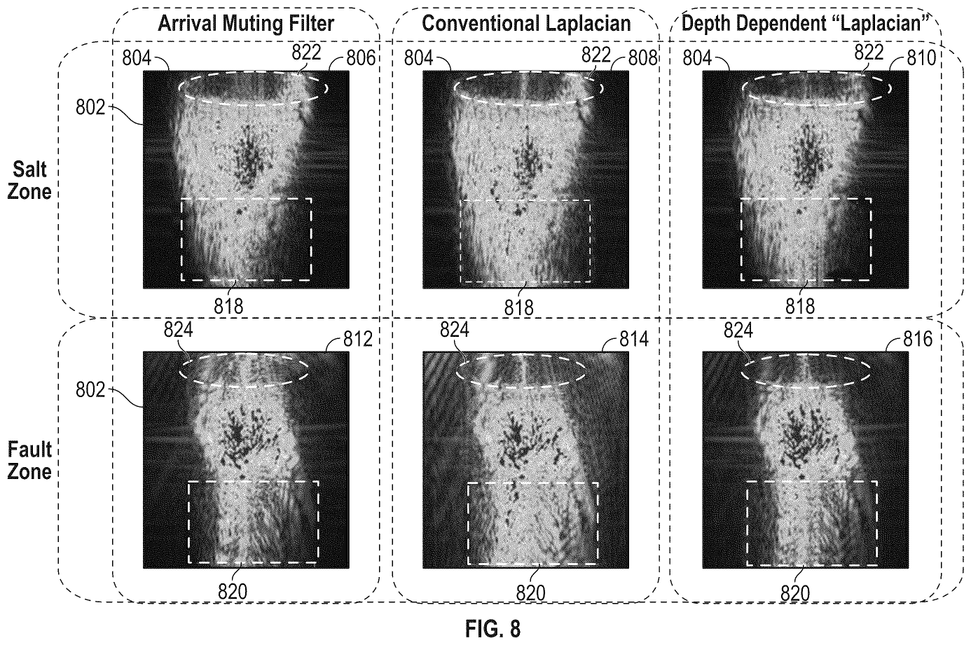

The wavenumber domain results of implementing the different filtering methods are compared and contrasted in FIG. 8. FIG. 8 shows the amplitude of the filtered seismic images in the wavenumber domain. In all images of FIG. 8 the vertical axis indicates the vertical wavenumber k_{z} (802) and the horizontal axis indicates the horizontal wavenumber kₓ(804). Filtered seismic images (806, 808, 810) correspond to the salt area and filtered seismic images (812, 814, 816) to the fault area. Filtered seismic images (806, 812) were processed with the arrival muting filtering while filtered seismic images (808, 814) were processed with the Laplacian operator as in Equation (2). Furthermore, filtered seismic images (810, 816) were processed with the depth-dependent attenuation filtering as given in Equations (5) and (6).

Keeping with FIG. 8, in FIG. 8 filtered seismic images (808, 814) illustrate high-wavenumber energy in the dashed rectangles (818, 820) that is amplified by the Laplacian operator. In contrast, the high-wavenumber energy (818, 820) is not amplified in seismic images (806, 812) and (810, 816) filtered with arrival muting filtering and the depth-dependent attenuation filtering respectively. However, in filtered seismic images (810, 816) the low-wavenumber energy enclosed by the dashed ellipse (822, 824) is more efficiently denoised by depth-dependent attenuation filtering, if compared to the arrival muting filtering of seismic images (806, 812) and to the Laplacian operator filtering of seismic images (808, 814). Therefore, for both the salt area (308) and the fault area (310), the depth-dependent attenuation filtering appears to be more effective in reducing low-wavenumber noise in a seismic image without amplifying high-wavenumber noise.

Returning to FIG. 6, in Block 640, a drilling target in the subsurface region may be determined based on the filtered seismic image, in accordance with one or more embodiments. A drilling target (530) in a wellbore (118) may be based on, for example, an expected presence of gas or another hydrocarbon. Locations in a seismic image (230) may indicate an elevated probability of the presence of a hydrocarbon and may be targeted by well designers. On the other hand, locations in a seismic image (230) indicating a low probability of the presence of a hydrocarbon may be avoided by well designers.

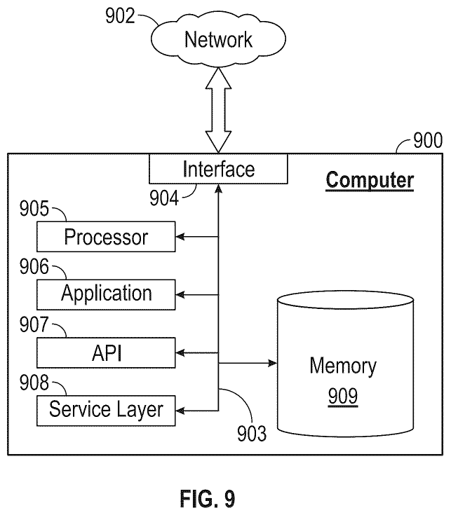

In Block 650, a wellbore trajectory to intersect the drilling target is planned using the seismic image, in accordance with one or more embodiments. Knowledge of the location of the drilling target (530) and the seismic image (230) may be transferred to a wellbore planning system (538). Instructions associated with the wellbore planning system (538) may be stored, for example, in the memory (909) within the computer system (900) described in FIG. 9 below. The wellbore planning system (538) may use the knowledge of the location of the drilling target (530) and of the seismic image (230) to plan a wellbore trajectory (504) within the subterranean region of interest (102).

In Block 660, a wellbore is drilled guided by the planned wellbore trajectory, in accordance with one or more embodiments. The wellbore planning system (538) may transfer the planned wellbore trajectory (504) to the drilling system (500) described in FIG. 5. The drilling system (500) may drill the wellbore (118) along the planned wellbore trajectory (504) to access and produce the hydrocarbon reservoir (104) to the surface (124).

In some embodiments the wellbore planning system (538) and the seismic processor (220) may each be implemented within the context of a computer system. FIG. 9 is a block diagram of a computer system (900) used to provide computational functionalities associated with described algorithms, methods, functions, processes, flows, and procedures as described in the instant disclosure, according to an implementation. The illustrated computer (900) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (900) may include a computer that includes an input device, such as a keypad, keyboard, touch screen, or other device that can accept user information, and an output device that conveys information associated with the operation of the computer (900), including digital data, visual, or audio information (or a combination of information), or a GUI.

The computer (900) can serve in a role as a client, network component, a server, a database or other persistency, or any other component (or a combination of roles) of a computer system for performing the subject matter described in the instant disclosure. The illustrated computer (900) is communicably coupled with a network (902). In some implementations, one or more components of the computer (900) may be configured to operate within environments, including cloud-computing-based, local, global, or other environment (or a combination of environments).

At a high level, the computer (900) is an electronic computing device operable to receive, transmit, process, store, or manage data and information associated with the described subject matter. According to some implementations, the computer (900) may also include or be communicably coupled with an application server, e-mail server, web server, caching server, streaming data server, business intelligence (BI) server, or other server (or a combination of servers).

The computer (900) can receive requests over network (902) from a client application (for example, executing on another computer (900)) and responding to the received requests by processing the said requests in an appropriate software application. In addition, requests may also be sent to the computer (900) from internal users (for example, from a command console or by other appropriate access method), external or third-parties, other automated applications, as well as any other appropriate entities, individuals, systems, or computers.

Each of the components of the computer (900) can communicate using a system bus (903). In some implementations, any or all of the components of the computer (900), both hardware or software (or a combination of hardware and software), may interface with each other or the interface (904) (or a combination of both) over the system bus (903) using an application programming interface (API) (907) or a service layer (908) (or a combination of the API (907) and service layer (908). The API (907) may include specifications for routines, data structures, and object classes. The API (907) may be either computer-language independent or dependent and refer to a complete interface, a single function, or even a set of APIs. The service layer (908) provides software services to the computer (900) or other components (whether or not illustrated) that are communicably coupled to the computer (900). The functionality of the computer (900) may be accessible for all service consumers using this service layer (908). Software services, such as those provided by the service layer (908), provide reusable, defined business functionalities through a defined interface. For example, the interface may be software written in JAVA, C++, or other suitable language providing data in extensible markup language (XML) format or other suitable format. While illustrated as an integrated component of the computer (900), alternative implementations may illustrate the API (907) or the service layer (908) as stand-alone components in relation to other components of the computer (900) or other components (whether or not illustrated) that are communicably coupled to the computer (900). Moreover, any or all parts of the API (907) or the service layer (908) may be implemented as child or sub-modules of another software module, enterprise application, or hardware module without departing from the scope of this disclosure.

The computer (900) includes an interface (904). Although illustrated as a single interface (904) in FIG. 9, two or more interfaces (904) may be used according to particular needs, desires, or particular implementations of the computer (900). The interface (904) is used by the computer (900) for communicating with other systems in a distributed environment that are connected to the network (902). Generally, the interface (904) includes logic encoded in software or hardware (or a combination of software and hardware) and operable to communicate with the network (902). More specifically, the interface (904) may include software supporting one or more communication protocols associated with communications such that the network (902) or interface's hardware is operable to communicate physical signals within and outside of the illustrated computer (900).

The computer (900) includes at least one computer processor (905). Although illustrated as a single computer processor (905) in FIG. 9, two or more processors may be used according to particular needs, desires, or particular implementations of the computer (900). Generally, the computer processor (905) executes instructions and manipulates data to perform the operations of the computer (900) and any algorithms, methods, functions, processes, flows, and procedures as described in the instant disclosure.

The computer (900) also includes a memory (909) that holds data for the computer (900) or other components (or a combination of both) that may be connected to the network (902). For example, memory (909) may be a database storing data consistent with this disclosure. Although illustrated as a single memory (909) in FIG. 9, two or more memories may be used according to particular needs, desires, or particular implementations of the computer (900) and the described functionality. While memory (909) is illustrated as an integral component of the computer (900), in alternative implementations, memory (909) may be external to the computer (900).

The application (906) is an algorithmic software engine providing functionality according to particular needs, desires, or particular implementations of the computer (900), particularly with respect to functionality described in this disclosure. For example, application (906) can serve as one or more components, modules, applications, etc. Further, although illustrated as a single application (906), the application (906) may be implemented as multiple applications (906) on the computer (900). In addition, although illustrated as integral to the computer (900), in alternative implementations, the application (906) may be external to the computer (900).

There may be any number of computers (900) associated with, or external to, a computer system containing computer (900), each computer (900) communicating over network (902). Further, the term “client,” “user,” and other appropriate terminology may be used interchangeably as appropriate without departing from the scope of this disclosure. Moreover, this disclosure contemplates that many users may use one computer (900), or that one user may use multiple computers (900).

In some embodiments, the computer (900) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining a seismic data regarding a subsurface region of interest, wherein the seismic data comprises a plurality of time-space waveforms;
obtaining a seismic velocity model;
determining a migrated seismic image based on the plurality of time-space waveforms and the seismic velocity model;
generating a filtered seismic image by applying a depth-dependent attenuation operator to the migrated seismic image; and
determining a drilling target in the subsurface region based on the filtered seismic image.

2. The method of claim 1, further comprising planning, using a wellbore planning system, a planned wellbore trajectory to intersect the drilling target.

3. The method of claim 2, further comprising drilling, using a drilling system, a wellbore guided by the planned wellbore trajectory.

4. The method of claim 1, wherein the depth-dependent attenuation operator comprises a function that decreases with depth.

5. The method of claim 1, wherein generating a filtered seismic image further comprises:
generating a transformed seismic image by transforming the migrated seismic image into components of a vertical wavenumber;
multiplying the transformed seismic image by a depth-dependent weight; and
performing an inverse transform.

6. The method of claim 1, wherein determining the migrated seismic image comprises performing reverse time migration.

7. The method of claim 1, wherein the depth-dependent attenuation operator comprises a power function of a vertical wavenumber.

8. The method of claim 5, wherein generating a transformed seismic image comprises performing short-window Fourier Transforms.

9. A non-transitory computer-readable medium comprising computer-executable instructions stored thereon that, when executed on a processor, cause the processor to perform:
obtaining seismic data regarding a subsurface region of interest, wherein the seismic data comprises a plurality of time-space waveforms;
obtaining a seismic velocity model;
determining a migrated seismic image based on the plurality of time-space waveforms and the seismic velocity model;
generating a filtered seismic image by applying a depth-dependent attenuation operator to the migrated seismic image; and
determining a drilling target in the subsurface region based on the filtered seismic image.

10. The non-transitory computer-readable medium of claim 9, further comprising computer-executable instructions that cause the processor to perform:
generating a transformed seismic image by transforming the migrated seismic image into components of a vertical wavenumber;
multiplying the transformed seismic image by a depth-dependent weight; and
performing an inverse transform.

11. The non-transitory computer-readable medium of claim 9, further comprising computer-executable instructions that cause the processor to perform:
determining the migrated seismic image by performing reverse time migration.

12. The non-transitory computer-readable medium of claim 9, further comprising computer-executable instructions that cause the processor to perform:
generating a transformed seismic image by performing short-window Fourier Transforms.

13. A system, comprising:
a seismic acquisition system configured to record seismic data regarding a subsurface region of interest, wherein the seismic data comprises a plurality of time-space waveforms; and
a seismic processor configured to receive the seismic data and to:
obtain a seismic velocity model,
determine a migrated seismic image based on the plurality of time-space waveforms and the seismic velocity model,
generate a filtered seismic image by applying a depth-dependent attenuation operator to the migrated seismic image, and
determine a drilling target in the subsurface region based on the filtered seismic image.

14. The system of claim 13, further comprising a wellbore planning system configured to plan a planned wellbore trajectory based, at least in part, on the filtered seismic image.

15. The system of claim 14, further comprising a drilling system configured to drill a portion of a wellbore guided by the planned wellbore trajectory.

16. The system of claim 13, wherein the depth-dependent attenuation operator comprises a function that decreases with depth.

17. The system of claim 13, wherein the seismic processor is further configured to:
generate a transformed seismic image by transforming the migrated seismic image into components of a vertical wavenumber;
multiply the transformed seismic image by a depth-dependent weight; and
perform an inverse transform.

18. The system of claim 13, wherein the seismic processor is further configured to determine the migrated seismic image by performing reverse time migration.

19. The system of claim 13, wherein the depth-dependent attenuation operator comprises a power function of a vertical wavenumber.

20. The system of claim 13, wherein the seismic processor is further configured to generate a transformed seismic image by performing short-window Fourier Transforms.
